(19) United States
(12) Patent Application Publication
(10) Pub. No.: US 2025/0181671 A1
(43) Pub. Date: Jun. 5, 2025

(54) CONFIDENCE METRIC DRIVEN MODEL OUTPUTS MANAGEMENT BY ACCOUNTING FOR UNCERTAINTY IN INPUT ENTITIES

(71) Applicant: Fair Isaac Corporation, Minneapolis, MN (US)

(72) Inventors: Scott Michael Zoldi, San Diego, CA (US); Maziar Yaesoubi, Roseville, MN (US)

(21) Appl. No.: 18/528,379

(22) Filed: Dec. 4, 2023

(51) Int. Cl. G06F 17/18

(52) U.S. Cl. CPC G06F 17/18

(57) ABSTRACT

A computer-implemented method, the method comprises receiving input feature data from a plurality of entities, wherein the plurality of entities comprises deterministic entities and uncertain entities, wherein the uncertain entities are subject to an indeterministic state; processing the input feature data derived from the deterministic entities using a first model to generate a first output; processing the input feature data derived from the deterministic entities and the uncertain entities using a second model to generate a second output; and selecting between the first output and the second output as a final output, wherein the selecting is based at least in part on a confidence level on the second output and a predetermined confidence threshold.

### TECHNICAL FIELD

The subject matter described herein relates to systems and methods for model outputs management in a decision management platform, for example for managing multiple models in machine learning systems.

### BACKGROUND

Machine learning models are widely used in various fields, including finance, healthcare, and technology, to make predictions or decisions based on input feature data. These models may be trained on a set of input features derived from various entities. The entities in the system can be categorized as either deterministic or uncertain. Deterministic entities may be characterized by their ability to provide data that is consistently in-order and up-to-date, either in real-time or near real-time, ensuring reliability and accuracy. On the other hand, uncertain entities may have data that is not in-order as current or reliable, with their state potentially being out-of-date or subject to transmission processing delays, leading to a degree of uncertainty in the feature data they provide. In many real-world applications, the input feature data is derived from a distributed and cloud data streaming platform. In such platforms, data is often processed in scalable methods which can cause out-of-order or out-of-sync data due to various factors such as network delays, processing delays, or congestion in the routing queues. This can lead to uncertainty in the state of the entities which the input feature data is used to derive features, and would be used subsequently in model scores and decisions. Despite the induced uncertainty, features from the uncertain entities may be valuable in training machine learning models, as it provides another dimension of input, and may produce a more comprehensive model. Therefore, there exists need to design a system and method to improve the performance of machine learning systems and models when some input entities from which some of input features of the model are derived might potentially go in an indeterministic state, for example, because of the uncertainty caused from out-of-order or out-of-sync data transmission.

### SUMMARY

Methods, systems, and articles of manufacture, including computer program products, are provided for model outputs management in machine learning systems. In one aspect, there is provided a system. The system may include at least one processor and at least one memory. The at least one memory may store instructions that result in operations when executed by the at least one processor. The operations may include: receiving input feature data from a plurality of entities, wherein the plurality of entities comprises deterministic entities and uncertain entities, wherein the uncertain entities are subject to an indeterministic state; processing the input feature data derived from the deterministic entities using a first model to generate a first output; processing the input feature data derived from the deterministic entities and the uncertain entities using a second model to generate a second output; and selecting between the first output and the second output as a final output, wherein the selecting is based at least in part on a confidence level on the second output and a predetermined confidence threshold.

In another aspect, there is provided a method. The method includes: receiving input feature data from a plurality of entities, wherein the plurality of entities comprises deterministic entities and uncertain entities, wherein the uncertain entities are subject to an indeterministic state; processing the input feature data derived from the deterministic entities using a first model to generate a first output; processing the input feature data derived from the deterministic entities and the uncertain entities using a second model to generate a second output; and selecting between the first output and the second output as a final output, wherein the selecting is based at least in part on a confidence level on the second output and a predetermined confidence threshold.

In another aspect, there is provided a computer program product including a non-transitory computer readable medium storing instructions. The operations include receiving input feature data from a plurality of entities, wherein the plurality of entities comprises deterministic entities and uncertain entities, wherein the uncertain entities are subject to an indeterministic state; processing the input feature data derived from the deterministic entities using a first model to generate a first output; processing the input feature data derived from the deterministic entities and the uncertain entities using a second model to generate a second output; and selecting between the first output and the second output as a final output, wherein the selecting is based at least in part on a confidence level on the second output and a predetermined confidence threshold.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to confidence metric driven model outputs management in machine learning systems by accounting for uncertainty in update of input entities, it should be readily understood that such features are not intended to be limiting. The claims that follow this disclosure are intended to define the scope of the protected subject matter.

This system enhances the performance of machine learning models by effectively managing uncertain input data and the impact of the uncertainty of the input data. The approach may quantify the impact of indeterministic states of input entities on the model's confidence level. Utilizing a dual-model approach, one model processes deterministic input data, and a second model may handle uncertain input data. This method ensures a thorough analysis of all inputs. Other significant features of the system may include the simulation of various states of data uncertainty, allowing the model to adapt to different scenarios. The system may utilize a probability distribution function that measures the likelihood of uncertainty in the data. This function may be utilized to understand the relationship between input data and the model's output, and how uncertainties might influence the final decision. The system is designed to aid in making informed decisions in the presence of uncertain information, providing a higher level of precision in machine learning applications across various sectors. Each of these sectors benefits from the system's ability to handle and interpret uncertain data, leading to more reliable and actionable insights. It offers a solution for navigating through complex data and enhances the reliability of predictive analytics.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating a schematic representation of an exemplary architecture in which a destination entity serves as one of the input feature data source for machine learning systems and is processed out of sync associated with different updating latencies, according to one or more embodiments consistent with the current subject matter;

FIG. 2 is a diagram illustrating a schematic representation of an exemplary architecture in which a destination entity serves as one of the input feature data source for machine learning systems and is processed and/or updated out of order, according to one or more embodiments consistent with the current subject matter;

FIG. 3 is a diagram illustrating a schematic representation of generating a quantified numerical distribution of likely true value conditioned on uncertainty by training a machine learning model using data derived from entities that are subject to indeterministic states, according to one or more embodiments consistent with the current subject matter;

FIG. 4 depicts a block diagram illustrating an example of a computing system, consistent with implementations of the current subject matter; and

FIG. 5 is a process flow diagram illustrating a process for the platform and systems provided herein to manage model outputs in machine learning systems, according to one or more implementations of the current subject matter.

When practical, like labels are used to refer to same or similar items in the drawings.

### DETAILED DESCRIPTION

The details of one or more variations of the subject matter described herein are set forth in the accompanying drawings.

As discussed herein elsewhere, in the realm of machine learning and data processing, a variety of entities may contribute to the input feature data that is processed by models. These entities may be classified into two broad categories: deterministic entities and uncertain entities. In some embodiments, uncertain entities are subject to an indeterministic state, meaning their data may not be accurate at some time points, for example, due to transmission delay or out of order processing of data transmission in distributed processing systems.

Machine learning models may operate in environments where access to disparate entities and data impacting the model may be at different levels of correctness due to latency differences in updating entity values in one or more registry, or nonoptimality of scaling methodologies such as affinity routing. This can lead to uncertainty in some data elements and certainty in others. In distributed and cloud data streaming platforms, the indeterministic state of uncertain entities can be caused by out-of-order or out-of-sync processing of data transmissions. This can be due to the heterogenous lags in access channels or processing delays in distributed computing systems causing uncertainty disparity of update of different classed entities related to the stream of data. Another source of uncertainty may be due to out-of-order update of corresponding entities. A load balancer, a component of a distributed and cloud data streaming platform, may follow a routing strategy typically based on affinity routing. This strategy is designed to minimize processing time while maintaining perfect order in each partition related to an affinity hash. However, when updating shared classed entities, there is an inherent level of uncertainty on the ordering on these entities as it is not included in the affinity routing hash. This can lead to sub-optimum time ordering performance or inaccurate order of processing with respect to these classed entities. These uncertainties of the data associated with a subset of the entities for machine learning operationalization may require a deterministic criterion to balance uncertainty risk associated with the prediction value.

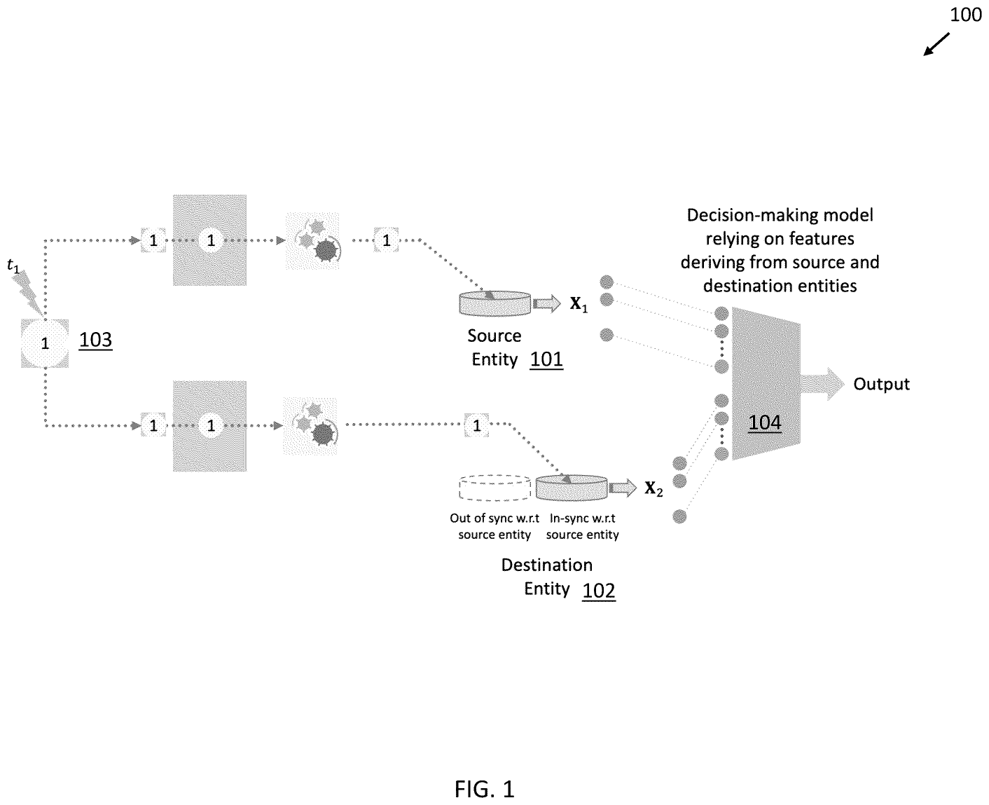

FIG. 1 is a diagram illustrating a schematic representation of an exemplary architecture 100 in which a destination entity serves as one of the input feature data source for machine learning systems and is processed out of sync associated with different updating latencies, according to one or more embodiments consistent with the current subject matter. As shown in FIG. 1, in some embodiments, the architecture 100 may be distributed and cloud data processing systems, wherein it may be designed to provide optimization for rapid and scalable handling of data streams. However, as shown in FIG. 1, the architecture 100 shows transitory discrepancies may exist in shared information among disparate classed entities. As shown in FIG. 1, an event 103 may occur at time point t1, and this may initiate update requests for two distinct classed entities, e.g., the source entity 101 and the destination entity 102. In some scenarios, due to variable processing delays, one entity may be updated prior to the other, thereby resulting in a transient disparity with respect to the timing of the event. Therefore, the input feature data to machines learning models 104 may include data from an entity that is subject to indeterministic states, for example, destination entity 102 in this example.

Machine learning models are conventionally built on the presumption of consistent data availability and the synchronicity of updates across all contributing data sources. Nonetheless, as described here elsewhere, during practical operations, these conditions are frequently not met. Variability in the temporal processing of data transmission streams—such as those depicted in FIG. 1—by the processing modules, may introduce an element of uncertainty into linked entities that constitute inputs to a machine learning model 104 (e.g., a decision model). Such out-of-order or unsynchronized processing can stem from heterogeneous delays across access channels or from processing time discrepancies within distributed computing frameworks, thereby leading to an update asynchrony amongst differentially classified entities involved in the data stream. Consequently, this may provide a state of the model wherein certainty is known in some data entities, while uncertainty is possible in other entities. For example, the event 103 in FIG. 1 may represent the detection of motion by a motion sensor (i.e., the source entity 101), would typically initiate simultaneous update requests to interconnected devices, for example, an image recognition system looking for an image of animal or human to generate notification or take a picture (i.e., the destination entity 102). In some embodiments, due to various reasons, the image recognition system may not be updated immediately once a motion is detected, thereby adding uncertainty to the data derived from the imagine recognition system resulting in not notifying or capturing the picture. In some embodiments, a particular event 103, namely the initiation of a financial transaction involving a source 101 and a destination entity 102, may generate simultaneous update requisitions for each involved entity. In the context of a financial transaction, this would typically correspond to a profile update pertinent to both the source entity 101 and destination entity 102 to accurately reflect the transaction's temporal progression. However, the inherent indeterminacy in the update latency for each entity may result in one entity processing the update in a more expeditious timeframe than its counterpart. Such an incongruity can exert a detrimental effect on the functionality of decision-making models 104 that rely on the assumption of uniform update timing across all input entities, as is the case with systems designed to identify fraudulent financial activities.

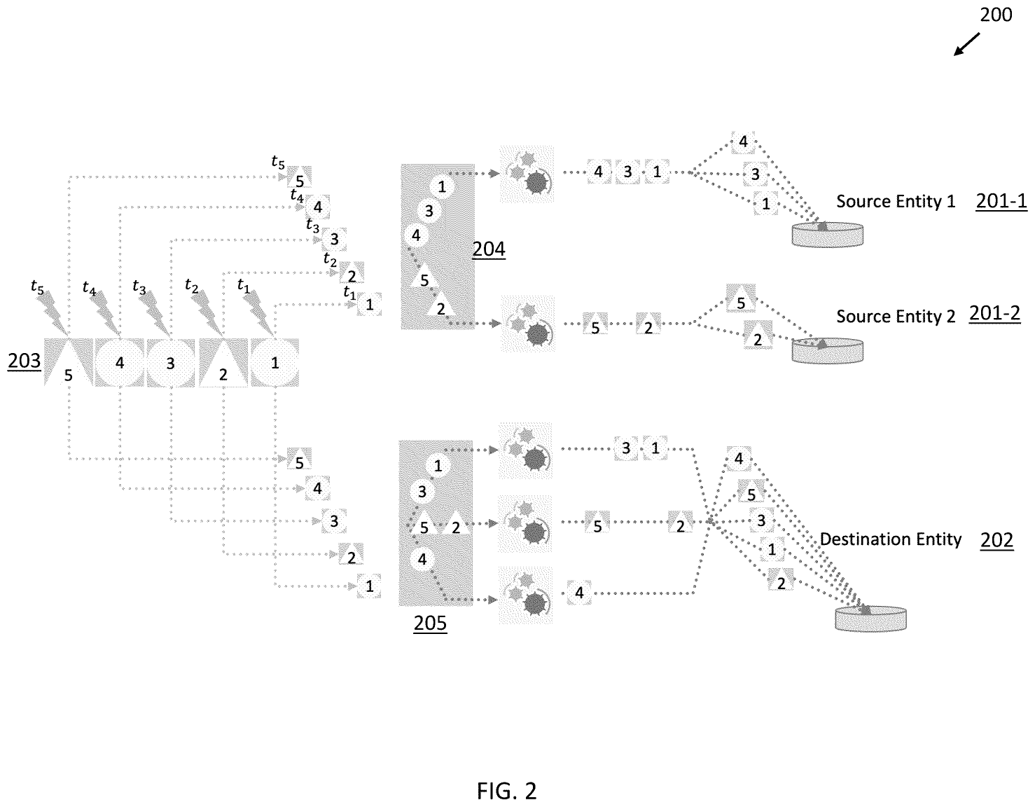

FIG. 2 is a diagram illustrating a schematic representation of an exemplary architecture 200 in which a destination entity serves as one of the input feature data source for machine learning systems and is processed and/or updated out of order, for example, for being associated with hashed scaling of update of entities, according to one or more embodiments consistent with the current subject matter. As shown in FIG. 2, the architecture 200 may include multiple source entities 201, one or more destination entity 202, a producer 204, and/or a load balancer 205; wherein one or more data transmission and/or events 203 may be facilitated by the architecture 200. As shown in FIG. 2, a plurality of event 203 may occur at different time points, e.g., t1-t5. In some embodiments, the architecture 200 may not present perfect synchronization, particularly pertaining to the destination entity 202. Update requests directed towards the destination entity 202 may be received in a sequentially correct manner by the load balancer 205; however, as illustrated, the initial request may be directed to a processing unit that subsequently processes the request following the receipt of a subsequent data transmission (i.e., data packets, e.g., online financial transaction). These requests originate from distinct sets of data transmission as depicted in FIG. 2, each may be associated with unique source classed entities. This may lead to an inability of the destination entity 202 to accurately update due to the disordering of events, resulting in a transient state of disarray due to varying workloads across the affinity queues. In some embodiments, the load balancer 205 operates on an affinity routing strategy that may be designed to minimize processing time and maintain sequential integrity within each partition associated with an affinity hash. Nevertheless, this routing protocol may not encompass shared classed entities, which introduces an inherent level of uncertainty in the ordering of these entities since they are not incorporated within the affinity routing hash. Such a limitation can precipitate sub-optimal timing in the processing sequence or, more critically, inaccuracies in the order of updates for these shared classed entities, as is the case with the destination entity 202 depicted in FIG. 2. As shown in FIG. 2, a sequence of events 203 is depicted, and update requests may be disseminated to the pair of entities, specifically the source entity 201 and the destination entity 202 associated with a data transmission (e.g., a data packet, and/or an online transaction). The assumption may be that all events 203 will update a common shared class entity, for example, the destination entity 202. Under this assumption, a fraction of these events 203, represented by circles 1, 3, and 4, will update the source entity 201-1 within partition 1, while the remaining events, depicted as triangles 2 and 5, will update the source entity 201-2 within partition 2. In some embodiments, data segmented on the basis of an affinity hash may be processed in a sequence determined by the key/hash generated by the producer 204. However, an entity not encompassed by the affinity hash, such as a second class of shared entities like the destination entity 202, lacks a guaranteed order among the subsets of events as the load balancer 205 does not enforce sequential processing for these entities.

This issue may be exacerbated when the load balancer 205 is inundated with a multitude of update requests for various classed entities. For instance, in FIG. 2, although request 1 (circle) precedes request 2 (triangle) and each pertains to distinct partitions, the routing imperfections may result in the out-of-order processing of update requests for the destination entity 202. The absence of a defined order for the shared classed entity can be attributed to unpredictable delays in processing, network latency, uneven data distribution in the affinity hash, or congestion within the routing affinity queues. Consequently, while the data transmission for the entities based on the affinity partition may maintain perfect order, the associated second non-affinity routed transmission of entities may be not synchronized in terms of processing order with respect to the destination (second entity class) 202.

In light of these considerations, an optimized system should strategically determine dependence on entities susceptible to such intrinsic uncertainty. Such entities should be incorporated into the decision-making process when their inclusion substantively enhances the confidence of the model in the current decision-making process or within a decision boundary, with the uncertainty risk duly quantified and integrated into the decision-making process. This approach proposes a system and method that enables a decision-making model to recognize the probability of indeterministic states within a subset of classed input entities and determines a distribution of likely values if certain and to quantitatively reduce the impact of this probability on the confidence level of the model in its decision-making process.

In some embodiments, the machine learning models may include a variety of predictive model suitable for tasks such as scoring and event detection. For scoring, logistic regression, decision trees, random forests, and gradient boosting machines are commonly used due to their effectiveness in handling binary outcomes and complex, non-linear data relationships. In event detection, neural networks, particularly deep learning models, anomaly detection algorithms like Isolation Forests or One-Class SVMs, and ensemble methods combining various algorithms may be employed to identify unusual patterns or outliers indicative of fraudulent activities. These models may leverage large datasets to learn and recognize specific patterns, necessitating regular updates and retraining to stay effective against evolving trends.

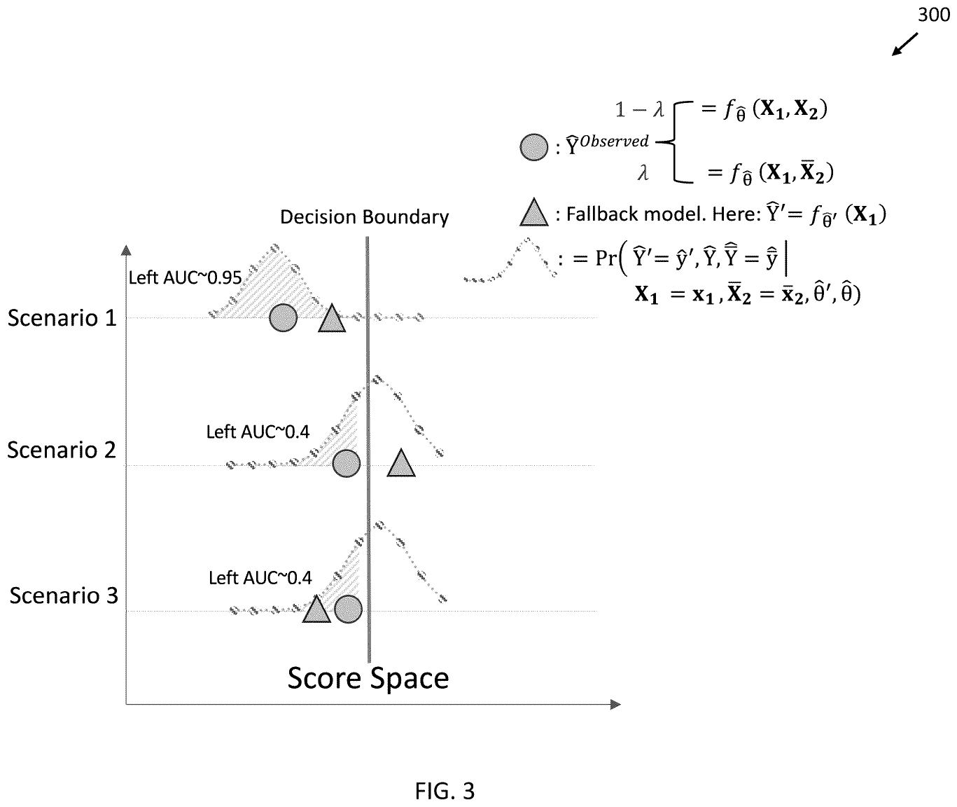

FIG. 3 is a diagram illustrating a schematic representation of generating a quantified numerical distribution of likely true value conditioned on uncertainty by training a machine learning model using data derived from entities that are subject to indeterministic states, according to one or more embodiments consistent with the current subject matter.

In some embodiments, provided herein is a system and method designed to facilitate an efficient quantitative assessment of the potential impact that an indeterministic state of a subset of classed input entities may have on the confidence level associated with a model's score. In some embodiments, a system and method are proposed to quantitatively evaluate the trade-offs involved in selecting a model that incorporates uncertain data, where such selection is contingent upon the level of confidence.

TABLE 1
Notations table

| | |
|---|---|
| X, x | Vector of 1-D random variables, |
| | Vector of scalar values |
| X, x | Vector of multi-dimensional |
| | random variables, instance of |
| | this matrix |
| X | scalar |

The system and method may rely on the following assumptions: the decision-making model is modeled as a known function ƒ_{θ}( ) with unknown set of parameters θ and two classes of input entities X₁=[X₁^{1 . . . n}] and X₂=[X₂^{1 . . . m}] and its outputs Y. As the notation table 1 suggests, n input features (X₁^{1 . . . n}) are derived from X₁ and similarly m input features are derived from X₂. In some embodiments, Y is the actual output of the model that is being used in the final decision-making process.

$$Y = {f}_{θ} ( {X}_{1} , {X}_{2} ) + ε$$

In the above equation, ε represents variation of true Y which is not explained by ƒ_{θ}( ) and is usually referred to as irreducible error in estimation of Y by ƒ_{θ}( ).

There are various algorithms that, given set of training examples [Y^{1 . . . n}, X_{1,2}^{1 . . . n}], can find an estimation of the unknown parameters θ (represented by \hat{θ}) such that Ŷ in the following equation would be the best estimation of Y given X₁ and X₂ and based on assumption that Var(ε|X₁, X₂)=σ² and E(ε|X₁, X₂)=0:

$$\hat{Y} = {f}_{\hat{θ}} ( {X}_{1} , {X}_{2} ) - ( uncertain model )$$

Another model may be generated by excluding X₂:

$${\hat{Y}}^{′} = {f}_{{\hat{θ}}^{′}} ( {X}_{1} ) - ( certain model )$$

By excluding X₂, the model may be referred to as certain model as it relies solely on the deterministic classed input entity X₁ and its derived features. On the other hand, the former model (Ŷ=ƒ_{\hat{θ}}(X₁, X₂)) has an uncertainty due to relying on input features derived from X₂, which as explained earlier, can be in indeterministic state due to asynchrony or out-of-order of input entities, therefore it is referred to as uncertain model.

In some embodiments, the system and method herein may measure uncertainty of this model due to the indeterministic state of X₂. For this measure, changes in Ŷ may be observed and measured when X₂ goes into indeterministic state (from now on it is represented as X̅₂). X̅₂ can either be generated by adding random noise to X₂ or simulation to model X̅₂ due to out-of-order and out-of-sync updates if the indeterministic state of X₂ is not well represented by a simple noise model. With either approach to create X̅₂, another random variable for \hat{Y̅} is generated such that \hat{Y̅}=ƒ_{\hat{θ}}(X₁, X̅₂), which is the uncertain model described above when X₂ is in indeterministic state.

In some embodiments, at each time point, the system and method described here may have an efficient quantitative estimation of the potential impact of indeterministic states of uncertain input entities (X₂, X̅₂) on the confidence level on output scores. With this quatitative estimation of impact, the system and method herein may make a decision on choosing between the outputs from the certain model and the uncertainty model, i.e., the resultant output for the machine learning system. In some embodiments, the outputs may include score from the certain model and the uncertain model. By constructing three random variables Ŷ′ (score of certain model independent of uncertain entity X₂), Ŷ (score of uncertain model when X₂ is in deterministic state) and \hat{Y̅} (score of uncertain model when X₂ is in indeterministic state), a likelihood function of these random variables may be formed as a joint Probability Distribution Function (PDF) to capture joint scoring behavior of these models under possibility of X₂ being in indeterministic state (i.e. X̅₂). In some embodiments, even though both Ŷ and \hat{Y̅} are based on shared model function ƒ_{\hat{θ}}( ) but Ŷ is fed X₂ and \hat{Y̅} is fed X̅₂ (uncertain), the disturbed version of same data points of X₂. Having these model functions, the desired joint-PDF may be formed by running these models on the same dataset of X₁, X₂ and X̅₂.

This PDF may enable capture of the intrinsic dependency between joint scoring behavior of the models as well as likelihood of X₂ be in indeterministic state. In some embodiments, PDF may capture the intrinsic dependency between joint scoring behavior of the first model and the second model when X₂ is in indeterministic state. For example, deviation degree between these model scores can be dependent on the deterministic vs. indeterministic state of X₂, which is captured in this joint PDF.

Moreover, this PDF may enable modeling the uncertainty of score Ŷ when X₂ is in indeterministic state, because a PDF is of the form: Pr(Ŷ′=ŷ′, Ŷ, \hat{Y̅}=\hat{y̅}|X₁=x₁, X̅₂=x̅₂, \hat{θ}′, \hat{θ}). This PDF may capture when known that X₂ is in indeterministic state, the distribution (not value) of true score Ŷ may be presented.

An additional measure λ is introduced, which represents the probability that X₂ is in fact in indeterministic state. This probability may either be estimated by observing occurrence rate of indeterministic state of X₂ from real data or based on prior knowledge or it can be estimated via a separate predictive model hence it can be a function of X₁ and X₂ since some input features derived from both X₁ and X₂ can have some predictive power for λ. For example, in the example of financial transaction, input features that capture velocity of transactions can be a good predictors of occurrence rate of indeterministic state of X₂.

An efficient estimation of the uncertain model's confidence in its score with respect to a decision boundary given the possibility of indeterministic state of X₂ may be provided. In many decision-making models, a required decision is may be presented with respect to a form of decision boundary. This means that in many instances, it is only required to have confidence on where the output of the model lies with respect to a pre-determined decision boundary in the output score space.

Referring to FIG. 3, three different scenarios based on where the observed score of uncertain model (Ŷ^{Observed}/Circle) and a fallback model (in this case certain model Ŷ′/triangle) lie in the score space. If X₂ is in deterministic state then Ŷ^{Observed}=Ŷ (Circle in FIG. 2) and if X₂ is in indeterministic state then Ŷ^{Observed}=\hat{Y̅} and Ŷ˜PDF (dashed plot). This is because if X₂ is indeterministic, the output of uncertain model can not be fully relied upon, and Ŷ would be best described as a random variable with a PDF of the form Pr(Ŷ′=ŷ′, Ŷ, \hat{Y̅}=\hat{y̅}|X₁=x₁, X̅₂=x̅₂, \hat{θ}′, \hat{θ}), as shown in FIG. 3. In this case, the probability that true Ŷ lies on either side of the decision boundary may be measured, for example, by calculating Area Under the Curve (AUC) of this PDF on both sides of the decision boundary.

In short: if the input of X₂ is deterministic, the observed score Ŷ^{Observed} is equal to Ŷ. If the input of X₂ is indeterministic, the observed score is represented by Ŷ^{Observed}=\hat{Y̅}, and the model output is considered a random variable with a probability density function (PDF) demoted by Pr(Ŷ′=ŷ′, Ŷ, \hat{Y̅}=\hat{y̅}|X₁=x₁, X̅₂=x̅₂, \hat{θ}′, \hat{θ}).

In scenario 1, since both uncertain model and fallback model agree on the side of the decision boundary, the model may rely on Ŷ^{Observed} regardless of the potential of indeterministic state of X₂. In some embodiments, in scenario 1, based on Left AUC (LAUC) measure and the current observation of Ŷ, even if the fallback model had not agreed with Ŷ^{observed}, the output from Ŷ^{Observed} may still be chosen to be the final output based on the fact that true Ŷ lies on the left side of decision boundary regardless of the deterministic state of X₂. In short, in this scenario, because both models agree on the outcome, the observed score from the uncertain model is trusted. In some embodiments, the output from Ŷ^{Observed} may choose the second output if the outputs from the uncertain model and fallback model agree on the side of the decision boundary, and the output from the uncertain model is within an uncertainty threshold. In some embodiments, the uncertainty threshold may be predetermined, and may indicate a tolerant to the impact of indeterministic state of X₂ to the uncertain model.

In scenario 2, based on estimated AUC of the PDF (LAUC=0.4) and current estimation of the probability of X₂ be in indeterministic state (λ), the system may assign probability of λ*(0.4) that true Y lie on the left land side of decision boundary in contradiction with Ŷ′. This measure may enable determination that if Ŷ^{Observed} or Ŷ′ (observation from uncertain and certain model respectively) may be replied upon, based on a pre-determined confidence threshold (e.g., set to be say <0.5% chance of being wrong). In this example, assume the score space is non-negative integers in the interval [0, 1000] and the decision boundary is set at 875. The tolerance for uncertainty in Ŷ due to indeterministic state of X₂ is set to be less than 1%. In this case, the estimated probability that true Ŷ in scenario 2 lies on the contradictory side of the decision boundary (disagreeing with Ŷ′) may be 1%*Left AUC (0.4), resulted in a 0.4%, Based on this computed uncertainty of 0.4% being within confidence threshold 0.5%, the operator may elect to accept the Ŷ^{Observed} value and take the decision on the lefthand and contrary to the decision if relying on Ŷ′.

In scenario 3, even though the chance that true Ŷ is on the right side of decision boundary passes our threshold, the output from Ŷ is still elected as the final output. This is because both scores of uncertain model and fallback model agree on the side of decision boundary. In short, the decision favors the observed score even when it may not meet the threshold because both models concur on the outcome.

Use Case-Smart Agriculture System with IoT Devices

In a smart agriculture system designed to optimize irrigation based on soil moisture levels, the system may include two types of Internet of Things (IoT) sensors: Soil Moisture Sensors (SMS) as deterministic entities and Weather Forecast Receivers (WFR) as uncertain entities due to the latency of updates associated with weather forecasts. A machine learning model may be trained to decide when and how much to irrigate based on data from these sensors. Referring to FIG. 3, in scenario 1, the model's observed score for irrigation needs, denoted by Ŷ^{Observed} (represented as a circle), aligns with the fallback model's score Y (represented as a triangle). In some embodiments, model trained on the SMS data indicates a definitive need for water, and the uncertain model trained on both SMS data and WFR data supports this despite its inherent uncertainty. Since the outputs from both model agree, the system proceeds to irrigate as per the observed score from the uncertain model.

In scenario 2, the model trained on SMS data suggests that the soil is approaching dryness, while the uncertain model trained on both SMS data and WFR data predicts rain, adding uncertainty to the decision. The model's observed score is inherently uncertain. By calculating the AUC of the model's PDF, there is a 40% probability that the model using SMS data and WFR data is on the watering side of the decision boundary. The tolerance for uncertainty in the uncertain model due to indeterministic state of the WDR data is set to be less than 1%. In this case, the estimated probability that true output lies on the watering needed side of the decision boundary may be 1%*0.4. The operator, with a set confidence threshold of less than 0.5% chance of making a wrong decision, opts to wait rather than irrigate immediately, as the calculated risk of not irrigating, which is 0.4% is within acceptable bounds of 0.5%.

In scenario 3, the model trained on SMS data shows the soil is at optimal moisture and therefore watering is not needed, while the uncertain model trained on both SMS data and the WFR data supports watering is not needed. Both the uncertain model and the fallback model agree that no irrigation is needed. Even though the WFR data is less reliable, the uncertain model relying on both SMS data and the WFR data generates a prediction that aligns with the fallback model trained on the SMS data. The system, therefore, decides against irrigation, reinforcing the decision with high confidence due to the agreement between both models.

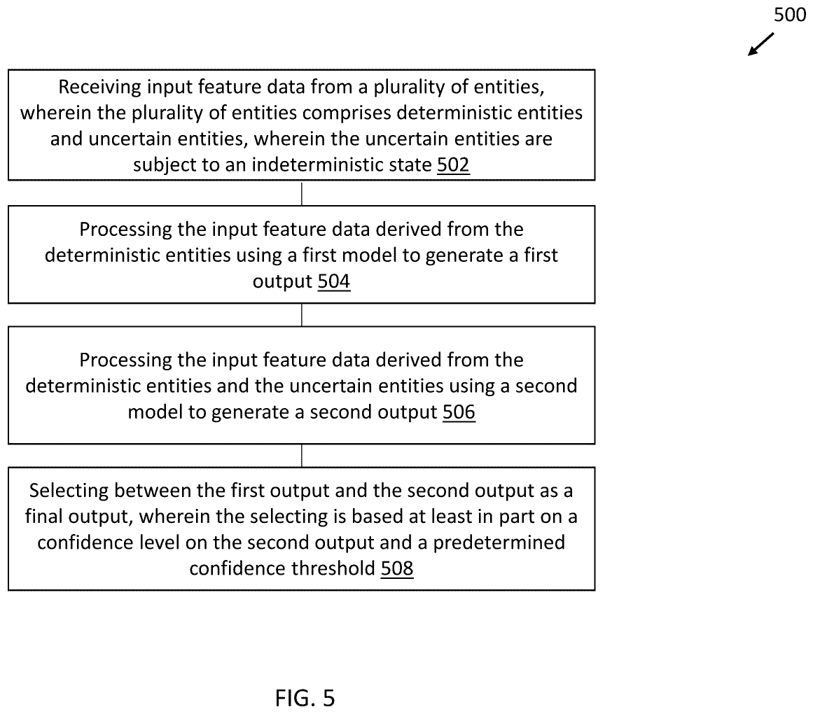

FIG. 5 is a process flow diagram illustrating a process 500 for the platform and systems provided herein to manage model outputs in machine learning systems, according to one or more implementations of the current subject matter. The process 500 may begin with operation 502, wherein the system may receive input feature data from a plurality of entities, wherein the plurality of entities include deterministic entities and uncertain entities, wherein the uncertain entities are subject to an indeterministic state. In some embodiments, deterministic entities are characterized by data that remain in-sync and properly sequenced, while uncertain entities are those that are susceptible to data becoming out-of-sync or experiencing sequence disruptions. In some embodiments, input feature data may include a range of variables depending on the specific application. For smart agriculture applications, the input feature data may encompass a variety of agricultural and environmental variables. For example, it may include soil moisture levels, temperature readings, humidity levels, sunlight exposure, and rainfall data. Additional data might cover plant growth stages, leaf water content, nutrient levels in the soil, and historical crop yield data. These inputs are crucial for enabling precise irrigation control, disease prediction, crop health monitoring, and overall efficient farm management in smart agriculture systems. For an IoT system operating on an assembly line, the input feature data may include various parameters that are critical for monitoring and optimizing the manufacturing process. This could encompass real-time metrics such as machine speed, temperature, vibration, and pressure readings from equipment. Additionally, data on product dimensions, weight, and quality inspection results (like images or scans for defect detection) may be included. Other relevant inputs might include the status of raw materials, environmental conditions like humidity and ambient temperature, energy consumption data, and even the efficiency and output rates of different assembly line segments. Collectively, these data points for an IoT system may be used to ensure optimal performance for training the machine learning models to enhance efficiency in the manufacturing process.

Next, the process may proceed to operation 504, wherein the system may process the input feature data derived from the deterministic entities using a first model to generate a first output. In some embodiment, the first model may be a certain model because it is trained on the input feature data derived from the deterministic entities. The process may then proceed to operation 506, wherein the system may process the input feature data derived from the deterministic entities and the uncertain entities using a second model to generate a second output. In some embodiments the second model may be an uncertain model because it is trained on the input feature data derived from both deterministic entities and uncertain entities. The process may then proceed to operation 508, wherein the system may select between the first output and the second output as a final output, wherein the selection may be based on a confidence level on the second output and a predetermined confidence threshold. In some embodiments, the confidence level on the second output may include a confidence level regarding the second output would past a decision boundary. In some embodiments, if the first output and the second output lies on a same side of a decision boundary, then the system may select the second output as the final output. In some embodiments, if the first output and the second output lies on contrary sides of the decision boundary, then the system may calculate a quantitative uncertainty measure of the second model. The quantitative uncertainty measure is a numerical estimation of an impact of indeterministic states of uncertain input entities on the confidence level of the second output (i.e., as calculated in scenario 2 in connection with FIG. 3). In some embodiments, if the quantitative uncertainty measure is within the predetermined confidence threshold, then the system may select the second output. If the quantitative uncertainty measure is outside of the predetermined confidence threshold, then the system may select the first output. This means that the first output and second output do not agree with each other in terms of a binary decision (i.e., falls on opposite sides of the decision boundary), and an impact on the confidence level exceeds a pre-determined tolerant (predetermined confidence threshold), therefore, the first output from the first model should be used as the final output.

In some embodiments, to calculate the quantitative uncertainty measure, the system may start with generating three random variables representing a score of the first model, a score of the second model when the uncertain entities are in a deterministic state, and a score of the second model when the uncertain entities are in the indeterministic state (as illustrated by the three random variables in connection with FIG. 3). Next, the system may form a joint Probability Distribution Function (PDF) of the three random variables to capture a joint scoring behavior of the models under a possibility of the uncertain entities being in an indeterministic state. In some embodiments, the system may model uncertainty of the second model's score when the uncertain entities are in the indeterministic state using the joint PDF, by calculating an Area Under the Curve (AUC) of the PDF on both sides of the decision boundary in an output score space. In some embodiments, the system may introduce an additional measure representing a probability that the uncertain entities are in fact in the indeterministic state, which can be estimated by observing an occurrence rate of the indeterministic state based on prior knowledge. In some embodiment, the system may calculate the quantitative uncertainty measure based on the probability that the uncertain entity is in the indeterministic state and the AUC of the PDF on the side of the decision boundary that contradicts an observed score of the second model. In some embodiments, the predetermined confidence threshold is a specific value representing a tolerance for uncertainty in the second output due to the indeterministic state of the uncertain entities.

As described herein elsewhere, the input feature data may be derived from a number of entities in a distributed and cloud data streaming platform, the indeterministic state of the uncertain entities may be caused by out-of-order or out-of-sync processing of data transmissions in the platform.

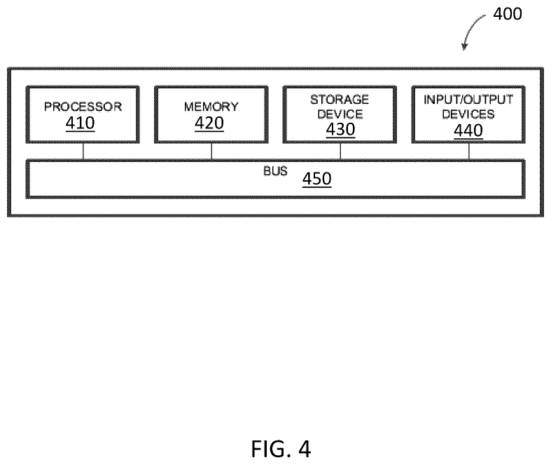

FIG. 4 depicts a block diagram illustrating a computing system 400 consistent with implementations of the current subject matter. As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The computing system 400 may additionally or alternatively include a graphic processing unit (GPU), such as for image processing, and/or an associated memory for the GPU. The GPU and/or the associated memory for the GPU may be interconnected via the system bus 450 with the processor 410, the memory 420, the storage device 430, and the input/output devices 440. The memory associated with the GPU may store one or more images described herein, and the GPU may process one or more of the images described herein. The GPU may be coupled to and/or form a part of the processor 410. The processor 410 is capable of processing instructions for execution within the computing system 400. Such executed instructions can implement one or more components. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method, comprising:
receiving input feature data from a plurality of entities, wherein the plurality of entities comprises deterministic entities and uncertain entities, wherein the uncertain entities are subject to an indeterministic state;
processing the input feature data derived from the deterministic entities using a first model to generate a first output;
processing the input feature data derived from the deterministic entities and the uncertain entities using a second model to generate a second output; and
selecting between the first output and the second output as a final output, wherein the selecting is based at least in part on a confidence level on the second output and a predetermined confidence threshold.

2. The method of claim 1, wherein the input feature data is derived from the plurality of entities in a distributed and cloud data streaming platform, and wherein the indeterministic state of the uncertain entities is caused by out-of-order or out-of-sync processing of data transmissions in the platform.

3. The method of claim 1, further comprising constructing a joint Probability Distribution Function (PDF) by running the first model and the second model on a same dataset derived from the deterministic entities and the uncertain entities, wherein the joint PDF provides intrinsic dependency between joint scoring behavior of the first model and the second model when the uncertain entities are in the indeterministic state, and wherein the confidence level on the second output is based at least in part on the intrinsic dependency.

4. The method of claim 1, further comprising selecting the second output if the first output and the second output lies on a same side of a decision boundary.

5. The method of claim 4, further comprising selecting the second output if the first output and the second output lies on a same side of a decision boundary and the second output is within an uncertainty threshold.

6. The method of claim 4, further comprising:
calculating a quantitative uncertainty measure of the second output and determine whether first output and the second output lies on contrary sides of the decision boundary;
selecting the second output if the quantitative uncertainty measure is within the predetermined confidence threshold, and
selecting the first output if the quantitative uncertainty measure is outside of the predetermined confidence threshold,
wherein the quantitative uncertainty measure is a numerical estimation of an impact of indeterministic states of uncertain input entities on the confidence level of the second output.

7. The method of claim 6, wherein calculating the quantitative uncertainty measure comprises:
generating three random variables representing a score of the first model, a score of the second model when the uncertain entities are in a deterministic state, and a score of the second model when the uncertain entities are in the indeterministic state;
forming a joint Probability Distribution Function (PDF) of the three random variables to capture a joint scoring behavior of the models under a possibility of the uncertain entities being in an indeterministic state;
generating an uncertainty model by calculating an Area Under the Curve (AUC) of the PDF on both sides of the decision boundary in an output score space, wherein the uncertainty model captures uncertainty of the second model's score when the uncertain entities are in the indeterministic state;
introducing an additional measure representing a probability that the uncertain entities are in fact in the indeterministic state, wherein the probability is estimated by observing an occurrence rate of the indeterministic state based on prior knowledge; and
calculating the quantitative uncertainty measure based on the probability that the uncertain entity is in the indeterministic state and the AUC of the PDF on the side of the decision boundary that contradicts an observed score of the second model.

8. The method of claim 1, wherein the predetermined confidence threshold is a specific value representing a tolerance for uncertainty in the second output due to the indeterministic state of the uncertain entities.

9. A computer program product comprising a non-transient machine-readable medium storing instructions that, when executed by at least one programmable processor, cause the at least one programmable processor to perform operations comprising:
receiving input feature data from a plurality of entities, wherein the plurality of entities comprises deterministic entities and uncertain entities, wherein the uncertain entities are subject to an indeterministic state;
processing the input feature data derived from the deterministic entities using a first model to generate a first output;
processing the input feature data derived from the deterministic entities and the uncertain entities using a second model to generate a second output; and
selecting between the first output and the second output as a final output, wherein the selecting is based at least in part on a confidence level on the second output and a predetermined confidence threshold.

10. The computer program product of claim 9, wherein the input feature data is derived from the plurality of entities in a distributed and cloud data streaming platform, and wherein the indeterministic state of the uncertain entities is caused by out-of-order or out-of-sync processing of data transmissions in the platform.

11. The computer program product of claim 9, wherein the operations further comprise constructing a joint Probability Distribution Function (PDF) by running the first model and the second model on a same dataset derived from the deterministic entities and the uncertain entities, wherein the joint PDF provides intrinsic dependency between joint scoring behavior of the first model and the second model when the uncertain entities are in the indeterministic state, and wherein the confidence level on the second output is based at least in part on the intrinsic dependency.

12. The computer program product of claim 9, wherein the operations further comprise selecting the second output if the first output and the second output lies on a same side of a decision boundary.

13. The computer program product of claim 12, wherein the operations further comprise selecting the second output if the first output and the second output lies on a same side of a decision boundary and the second output is within an uncertainty threshold.

14. The computer program product of claim 9, wherein the predetermined confidence threshold is a specific value representing a tolerance for uncertainty in the second output due to the indeterministic state of the uncertain entities.

15. A system comprising:
at least one programmable processor; and
a non-transient machine-readable medium storing instructions that, when executed by the processor, cause the at least one programmable processor to perform operations comprising:
receiving input feature data from a plurality of entities, wherein the plurality of entities comprises deterministic entities and uncertain entities, wherein the uncertain entities are subject to an indeterministic state;
processing the input feature data derived from the deterministic entities using a first model to generate a first output;
processing the input feature data derived from the deterministic entities and the uncertain entities using a second model to generate a second output; and
selecting between the first output and the second output as a final output, wherein the selecting is based at least in part on a confidence level on the second output and a predetermined confidence threshold.

16. The system of claim 15, wherein the input feature data is derived from the plurality of entities in a distributed and cloud data streaming platform, and wherein the indeterministic state of the uncertain entities is caused by out-of-order or out-of-sync processing of data transmissions in the platform.

17. The system of claim 15, wherein the operations further comprise constructing a joint Probability Distribution Function (PDF) by running the first model and the second model on a same dataset derived from the deterministic entities and the uncertain entities, wherein the joint PDF provides intrinsic dependency between joint scoring behavior of the first model and the second model when the uncertain entities are in the indeterministic state, and wherein the confidence level on the second output is based at least in part on the intrinsic dependency.

18. The system of claim 15, wherein the operations further comprise selecting the second output if the first output and the second output lies on a same side of a decision boundary.

19. The system of claim 18, wherein the operations further comprise selecting the second output if the first output and the second output lies on a same side of a decision boundary and the second output is within an uncertainty threshold.

20. The system of claim 15, wherein the predetermined confidence threshold is a specific value representing a tolerance for uncertainty in the second output due to the indeterministic state of the uncertain entities.
